(19) United States
(12) Patent Application Publication
(10) Pub. No.: US 2015/0333528 A1
(43) Pub. Date: Nov. 19, 2015

(54) WIRELESS SOUND POWERED HOUSE

(71) Applicant: Energous Corporation, San Jose, CA (US)

(72) Inventor: Michael A. Leabman, Pleasanton, CA (US)

(21) Appl. No.: 14/276,606

(22) Filed: May 13, 2014

(51) Int. Cl. H02J 5/00; H04B 5/00; H02J 7/02

(52) U.S. Cl. CPC H02J 5/005; H02J 7/025; H04B 5/0037

(57) ABSTRACT

The present invention provides a wireless sound power system using wireless power transmission techniques such as pocket-forming. Wireless sound power system is used in a house to provide power and charge to a plurality of mobile and non-mobile devices therein. The wireless powered house often includes a single base station that is connected to several transmitters. The base station manages operation of every transmitter in an independently manner or operates several transmitters as a single transmitter. Connection between base station and transmitters may be achieved through a plurality of techniques including wired connections and wireless connections. In some embodiments, transmitters include one or more transducers connected to at least one sound wave integrated circuit with a micro-controller and a power source.

### CROSS-REFERENCES TO RELATED APPLICATIONS

The present disclosure is related to U.S. non-provisional patent application Ser. Nos. 13/891,430. filed May 10, 2013, entitled “Methodology for Pocket-forming”; 13/891,445. filed Jul. 22, 2013, entitled “Transmitters for wireless power transmission”; 13/946,065, filed Jul. 19, 2013 entitled “Home Base Station For Multiple Room Coverage With Multiple Transmitters”; 13/939,506, filed Jul. 11, 2013 entitled “Wireless Tracking Pocket Forming”; 13/926,020, filed June 25, 2013 entitled “Wireless Power Transmission with Selective Range”; 13/916,233, filed Jun. 12, 2013 entitled “Wireless Charging with Reflectors” and 13/925,469 filed Jun. 24, 2013, entitled “Methodology for Multiple Pocket-Forming” invented by Michael Leabman and Gregory Scott Brewer.

### FIELD OF INVENTION

The present disclosure relates to wireless sound power transmission, and more particularly to wireless sound powered house using a plurality of techniques and technologies for wireless power transmission.

### BACKGROUND OF THE INVENTION

Electronic devices such as laptop computers, smartphones, portable gaming devices, tablets and so forth may require power for performing their intended functions. This may require having to charge electronic equipment at least once a day, or in high-demand electronic devices more than once a day. Such an activity may be tedious and may represent a burden to users. For example, a user may be required to carry chargers in case his electronic equipment is lacking power. In addition, users have to find available power sources to connect to. Lastly, users must plugin to a wall or other power supply to be able to charge his or her electronic device. However, such an activity may render electronic devices inoperable during charging. In addition, cables infrastructure may include drilling on walls and conduit installation, which increase maintenance cost and may be non-esthetic.

In addition, some electronic devices may require restricted use in certain areas of the house, thus safety may be increased for children. Such devices may include: drillers, electric knives among others. Current technology allows these devices to operate in any electric plug.

Current solutions to these problems may include inductive pads which may employ magnetic induction or resonating coils. Nevertheless, such a solution may still require that electronic devices may have to be placed in a specific place for powering. Thus, electronic devices during charging may not be portable.

For the foregoing reasons, there is a need for a wireless power transmission system where electronic devices may be powered without requiring extra chargers or plugs, and where the mobility and portability of electronic devices may not be compromised.

### SUMMARY OF THE INVENTION

The present disclosure provides a plurality of wireless transmitters which can be utilized for wireless power transmission using suitable techniques such as pocket-forming. Such transmitters may he installed for charging and powering mobile and non-mobile devices in a house. Transmitters may he employed for sending sound wave (SW) signals to electronic devices which may incorporate receivers. Such receivers may convert SW signals into suitable electricity for powering and charging a plurality of electric devices. Wireless power transmission allows powering and charging a plurality of electrical devices without wires.

Wireless power system may include several transmitters located in different locations for enabling multiple room coverage. In order to improve this feature, a single base station may manage each transmitter in different location with different and independent operation modes. Furthermore, base stations may enable the use of all transmitters as a single transmitter.

Base stations may reduce the cost of a wireless power system, because specific circuitry may only be placed in base stations rather than on each transmitter. In addition, the use of a base station for controlling several transmitters may improve the managing and charging of several receivers.

Base station may use a CPU, computer, micro-controller among others components for processing information. from receivers and transmitters. Furthermore, a variety of protocol may be executed by base station in order to charge and power a plurality of mobile and non-mobile devices, such protocols may include priorities, restricted locations, and authentication among others. Protocols may be customized by the user.

Numerous other aspects, features and benefits of the present disclosure may be made apparent from the following detailed description taken together with the drawings provided.

### BRIEF DESCRIPTION OF THE DRAWINGS

The present disclosure can be better understood by referring to the following figures. The components in the figures are not necessarily to scale, emphasis instead being placed upon illustrating the principles of the disclosure. In the figures, reference numerals designate corresponding parts throughout the different views.

FIG. 1 illustrates a wireless power transmission example situation using pocket-forming.

FIG. 2 illustrates a component level embodiment for a wireless power system including three transmitters.

FIG. 3 illustrates a wireless powered house with a variety of transmitters and receivers.

FIG. 4 illustrates an example routine that may he utilized by a micro-controller from base station (as described in FIG. 2) to deliver power to receivers which may require wireless power transmission, according to an embodiment.

### DETAILED DESCRIPTION OF THE DRAWINGS

### Definitions

“Pocket-forming” may refer to generating two or more sound waves which converge in 3-d space, forming controlled constructive and destructive interference patterns.

“Pockets of energy” may refer to areas or regions of space where energy or power may accumulate in the form of constructive interference patterns of sound waves.

“Null-space” may refer to areas or regions of space where pockets of energy do not form because of destructive interference patterns of sound waves.

“Transmitter” may refer to a device, including a chip which may generate two or more SW signals, at least one SW signal being phase shifted and gain adjusted with respect to other SW signals, substantially all of which pass through one or more SW transducer such that focused SW signals are directed to a target.

“Receiver” may refer to a device including at least one sensor element, at least one rectifying circuit and at least one power converter, which may utilize pockets of energy for powering, or charging an electronic device.

“Adaptive pocket-forming” may refer to dynamically adjusting pocket-forming to regulate power on one or more targeted receivers.

### DESCRIPTION OF THE DRAWINGS

In the following detailed description, reference is made to the accompanying drawings, which form a part hereof. In the drawings, which are not to scale or to proportion, similar symbols typically identify similar components, unless context dictates otherwise. The illustrative embodiments described in the detailed description, drawings and claims, are not meant to be limiting. Other embodiments may be used and/or and other changes may be made without departing from the spirit or scope of the present disclosure.

As background, a sound waveform has the same characteristics as that of an electrical waveform which are Wavelength (λ), Frequency (f) and Velocity (m/s). Both the sounds frequency and wave shape are determined by the origin or vibration that originally produced the sound but the velocity is dependent upon the medium of transmission (air, water etc.) that carries the sound wave. Audio Sound Transducers include both input sensors, that convert sound into and electrical signal such as a Microphone and output actuators that convert the electrical signals back into sound such as a loudspeaker.

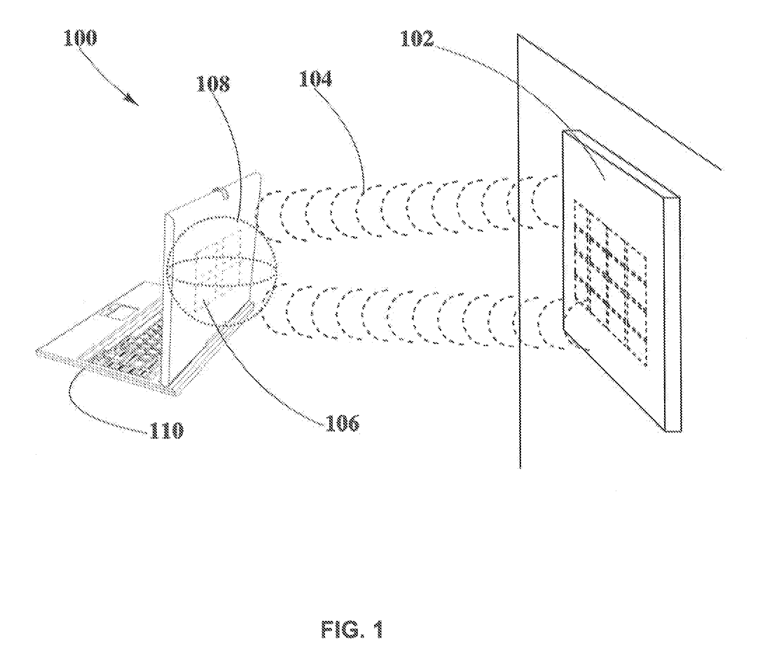

FIG. 1 illustrates wireless power transmission 100 using pocket-forming. A transmitter 102 may transmit controlled sound waves 104 which may converge in 3-d space. These sound waves (SW) waves 104 may he controlled through phase and/or relative amplitude adjustments to form constructive and destructive interference patterns (pocket-forming). Pockets of energy 108 may be formed at constructive interference patterns and can be 3-dimensional in shape whereas null-spaces may be generated at destructive interference patterns. A receiver 106 may then utilize pockets of energy 108 produced by pocket-forming for charging or powering an electronic device, for example a laptop computer 110 and thus effectively providing wireless sound power transmission 100. In other situations there can be multiple transmitters 102 and/or multiple receivers 106 for powering various electronic equipment for example smartphones, tablets, music players, toys and others at the same time. In other embodiments, adaptive pocket-forming may be used to regulate power on electronic devices.

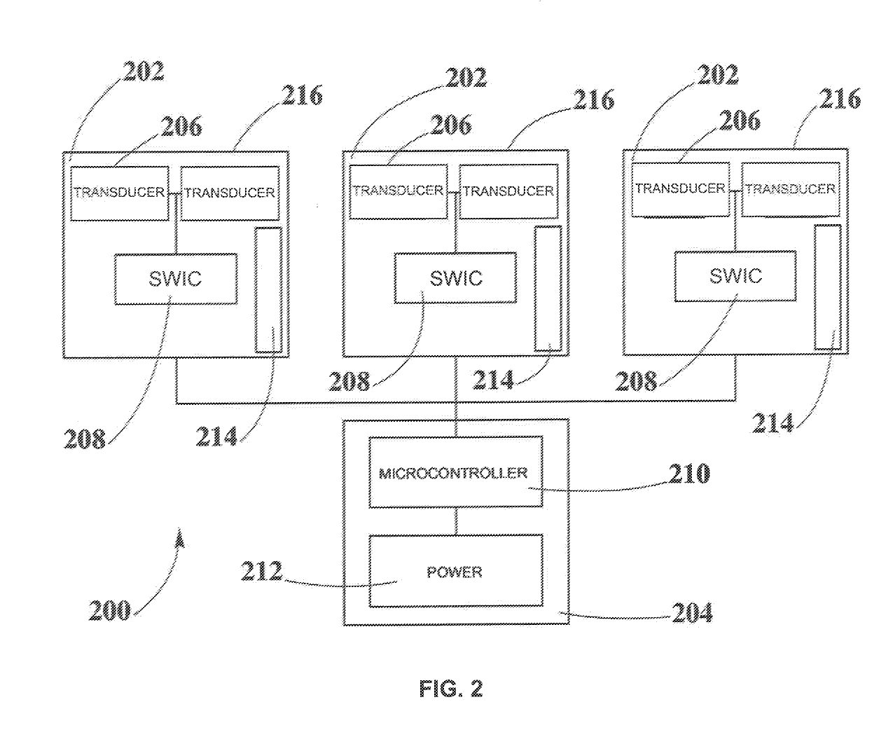

FIG. 2 depicts a block diagram of a wireless power system 200, which may include a plurality of wireless power transmitter 202 connected to a single base station 204. Transmitters 202 may include one or more transducer elements 206, one or more sound wave integrated circuit (SWIC) 208, a communication component 214 and a housing 216, which may allocate all the components previously mentioned. Base station 204 may include one or more micro-controller 210, a power source 212 and a housing 216, which may allocate all the components previously mentioned. Components in wireless power system 200 and base station 204 may be manufactured using meta materials, micro-printing of circuits, nano-materials, and the like.

Base station 204 may be located in variety of locations where transmitters 202 may stay connected to it. Such connection may include a variety of connections, which may include coaxial cable, phone cable, LAN cable, wireless connection among others. The connection between base station 204 and transmitters 202 aims to establish a. link between SWIC 208 and micro-controller 210, as well as the power source 212 connection.

Micro-controller 210 may control a variety of features of SWIC 208 such as, time emission of pocket-forming, direction of the pocket-foming, bounce angle, power intensity and the like. Furthermore, micro-controller 210 may control multiple pocket-forming over multiple receivers 106 or over a single receiver 106. In addition, micro-controller 210 may manage and control communication. protocols and signals by controlling communication component 214. Thus micro-controller 210 may drive the foregoing features in several transmitters 202 at the same time.

Base station 204 may be fed by a power source 212 which in turn may feed to transmitters 202. Power source 212 may include AC or DC power supply. Voltage, power and current intensity provided by power source 212 may vary in dependency with the required power to be transmitted. Conversion of power to radio signal may be managed by micro-controller 210 and carried out by SWIC 208, which may utilize a plurality of methods and components to produce SW signals in a wide variety of frequencies, wavelength, intensities and other features. As an exemplary use of a variety of methods and components for SW signal generation, oscillators and piezoelectric crystals may be used to create and change sound frequencies in different transducer elements 206. In addition, a variety of filters may be used for smoothing signals as well as amplifiers for increasing power to be transmitted.

Base station 204 may enable operation of different transmitters 202 in different rooms and/or areas coverage. Each transmitter 202 may operate at different frequencies, power intensities and different ranges. In addition, each transmitter 202 may provide power to a plurality of receivers 106. Furthermore, base station 204 may enable a single operation of all transmitter 202, thus may provide a higher capability for wireless charging by the use of each transmitter 202 as a single one.

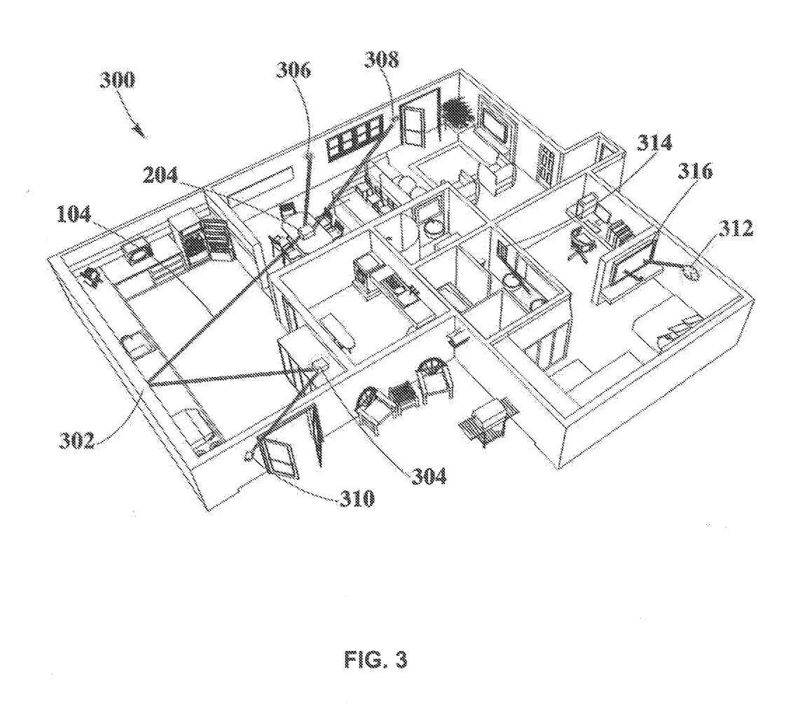

FIG. 3 depicts a wireless powered house 300, which may include a plurality of transmitters 202 connected to a single base station 204, which may also include a main transmitter 202. Base station 204 allows the charge management of mobile and non-mobile devices in wireless powered house 300. Additionally, transmitters 202 may be embedded into a plurality of electronic devices and objects in wireless powered house 300.

Base station 204 may enable communication between every transmitter 202 and receiver 106 in wireless powered house 300, as described in FIG. 2. Furthermore, wireless powered house 300 may include a variety of range enhancers, which may increase range of wireless power transmission 100, such range enhancers may include: reflectors 302 and wireless repeaters 304. Reflectors 302 may be included in several places of the wireless powered house 300, such as curtains, walls, floor, and ceiling among others. Wireless repeaters 304 may include a receiver 106 and a transmitter 202 for re-transmitting power. FIG. 3 illustrates an example for using reflectors 302 and wireless repeaters 304, where a CCTV camera 310 requires charge, but it is too far for receiving power at an optimal efficiency. However, base station 204 may trace a trajectory for SW waves 104 which may imply less loses and includes the use of reflectors 302 that may be embedded in the walls and a wireless repeater 304, which may receive the reflected SW waves 104 and re-transmits these to the CCTV camera 310 with higher power than the received.

As depicted in FIG. 3, base station 204 may send SW waves 104 to any device in wireless powered house 300, these devices may include static devices such as: Smoke detectors 306, digital door locks 308, CCTV cameras 310, wall clocks 312 among others devices that requires wired powered connections. The lack of cables for powering such devices may reduce work time for installing and maintaining those devices. Furthermore, walls, ceilings and floors may not require to be drilled for installing cables.

Device locations may be updated automatically by base station 204, which may set a communication channel between each device, regardless if it is a mobile or non-mobile device.

Some devices such as mirrors 314 may allow a transmitter 202 in order to charge small devices and disposable devices in the bathroom and/or in the bedroom. Such devices may include: Electric razors, electric toothbrushes, lamps, massagers, UV Sterilizers among others. Therefore, mirror 314 may significantly reduce wired chargers for each electric device in bathrooms and bedrooms.

Similarly to mirror 314, televisions 316 may include transmitters 202 powering and charging mobile and non-mobile devices.

Base station 204 may establish areas where wireless power transmission 100 may have specialized protocols, these areas may include infirmary, children rooms, room for pregnant and other regions where some devices may be sensitive to radio frequency waves but not to sound waves 104. Some areas may represent a permanent null space, where no pockets of energy 108 are generated. Furthermore, some receivers 106 may possess the same specialized protocols regardless their location in wireless powered house 300. Such devices may include electric knives, drills, and lighters among others. Therefore, each device may be restricted to a specific area and to a specific user, thus, safety in wireless powered house 300 may be higher than in conventional powered houses. Hence, children may not be to use harmful hardware and thieves may not be able to use stolen equipment outside the wireless powered house 300.

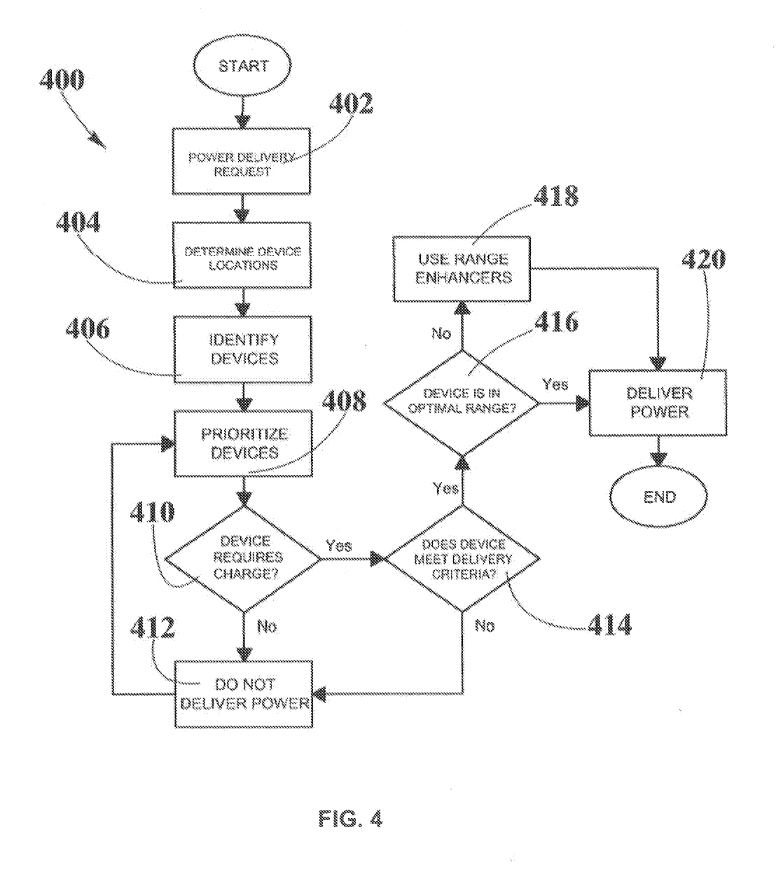

FIG. 4 illustrates an example routine 400 that may be utilized by micro-controller 210 from base station 204 in wireless powered house 300 to control wireless power transmission 100. Routine 400 may begin when any transmitter 102 in wireless powered house 300 receives a power delivery request step 402 from receiver 106. Subsequently, at Determine device locations step 404, a receiver 106 may send a signal via Bluetooth, SW waves 104, infrared among others to the closest transmitter 102. Then, transmitter 202 may determine location of receiver 106 in wireless powered house 300.

After this procedure, at identify devices step 406 receiver 106 sends a signature signal. to the closest transmitter 102, such signal may be coded using suitable techniques such as delay encoding, orthogonal frequency-division multiplexing (OFDM), code division multiplexing (CDM) or other suitable binary coding for identifying a given electronic device including receiver 106. At this step, micro-controller 210 may obtain information from receiver 106 such as type of device, manufacturer, serial number, total power required. Then, micro-controller 210 in base station 204 may proceed to authenticate where it may evaluate the signature signal sent by receiver 106. Micro-controller 210 may proceed to a decision. If receiver 106 is not authorized to receive power, micro-controller 210 may decide to block it, if receiver 106 is authorized, it may receive charge based on his assigned priority, such value is determined at prioritize devices step 408, such value may be set by the user preferences and charge level of the equipment, such charge level may be determined in device requires charge? Step 410. If the device does not requires charge, transmitter 102 may not charge it at do not deliver power step 412. Furthermore, such device may be listed as low priority to charge during prioritize devices step 408.

In addition, if multiple receivers 106 are requiring power, micro-controller 210 may deliver power equally to all receivers 106 or may utilize a priority status for each receiver 106. In some embodiments, the user may choose to deliver more power to its smartphone, than to its gaming device. In other cases, the user may decide to first power its smartphone and then its gaming device. Furthermore Smoke detectors 306, digital door locks 308 and CCTV cameras 310 among others similar devices, may be have the highest priority.

When the receiver 106 is authorized to receive charge, it has to meet some criteria at does device meet delivery criteria? Step 414. The foregoing powering criteria may depend on the electronic device requiring power and/or based in user preferences. For example, smartphones may only receive power if are not being used, or maybe during usage but only if the user is not talking through it or maybe during usage as long as Wi-fi is not compromised among other such criteria. In the case of a user custom profile, the user may specify the minimum battery level. its equipment can have before delivering power, or the user may specify the criteria for powering his or her device among other such options. In addition, in wireless powered house 300, some devices may possess some special criteria, as described in FIG. 3; such devices may be required to operate in specific rooms. Such devices may include drillers, electric knives, lighters, electric screwdrivers, saws, among others. Furthermore, some devices may require some user authentication, which may be achieved through password verification or biometric authentication. These two criteria may be used in combination for a maximum level of safety. Such combination may generate a single criterion related to parental control protocol, which may also include manage of power intensity for toys and operation areas for them.

Alternatively, micro-controller 210 may also record data on a processor on transmitter 102. Such data may include powering statistics related to how often does a device require power, at what times is the device requesting power, how long it takes to power the device, how much power was delivered to such device, the priority status of devices, where is the device mostly being powered (for example at home or in the workplace). In addition, such statistics could he uploaded to a cloud based server so that the user can look at all such statistics. Thus, the aforementioned statistics can help micro-controller 210 decide when to stop delivering power to such a user.

After does device meet delivery criteria? Step 414, micro-controller 210 in base station 204 may determine if receiver 106 is within the optimal range from the closest transmitter 102, such analysis may be carried out at device is in optimal range? Step 416. If receiver 106 is within the optimal range, then transmitter 102 may deliver power at deliver power step 420, if receiver 106 is out of the optimal range, then micro-controller 210 may use reflectors 302 and wireless repeaters 304 for increasing the optimal range, such operation may be performed at use range enhancers step 418. Subsequently, receiver 106 may receive charge at deliver power step 420.

While various aspects and embodiments have been disclosed herein, other aspects and embodiments may be contemplated. The various aspects and embodiments disclosed herein are for purposes of illustration and are not intended to be limiting, with the true scope and spirit being indicated by the following claims.

Having thus described the invention, we claim:

1. A method for wireless power transmission for electronic devices, comprising the steps of:
emitting SW waves from a plurality of pocket-forming transmitters each having a radio frequency integrated circuit, antenna elements, communication circuitry and a predetermined number of the plurality of pocket-forming transmitters connected to at least one base station having a digital processing unit and a power source connected to the digital processing unit and each of the predetermined number of transmitters;
generating pockets of energy from each transmitter to converge in and space at predetermined locations within a building or rooms within a predefined structure;
incorporating receivers within the electronic devices; and
converting the pockets of energy in 3-d space from each transmitter within the receivers located within range of each transmitter within the predefined structure to charge or power the electronic devices.

2. The method for wireless power transmission for electronic devices of claim 1, wherein the processing unit is a microprocessor, a C.P.U., a computer, micro-controller for processing information from the receivers and transmitters.

3. The method for wireless power transmission for electronic devices of claim 1, wherein the base station executes a variety of protocols in order to charge and power a plurality of mobile and non-mobile electronic devices.

4. The method for wireless power transmission for electronic devices of claim I, further including the step of controlling each of the plurality of transmitters from the base station to improve the managing and charging of the receivers.

5. The method for wireless power transmission for electronic devices of claim 1, wherein the plurality of transmitters connected to a single base station are located in different locations within the predefined structure, for enabling multiple room coverage or to manage each transmitter in different locations for enabling different and independent operation modes or in predetermined locations for enabling all of the plurality of transmitters as a single transmitter.

6. A method for wireless power transmission for electronic devices, comprising the steps of:
connecting a plurality of pocket-forming transmitters to at least one base station having a digital processor or a microcontroller or ASIC for controlling the transmitters;
connecting a power source to the digital processor and to the transmitters;
generating SW waves from a SW circuit embedded within each of the transmitters;
controlling the generated SW waves with the digital signal processor in each transmitter;
transmitting the SW waves through antenna elements connected to the transmitters within a predefined structure or building;
incorporating receivers within the electronic devices; and
capturing the SW waves forming pockets of energy converging in 3-D space at receivers located at predetermined locations within the structure to convert the pockets of energy into a DC voltage for charging or powering the electronic devices.

7. The method for wireless power transmission for electronic devices of claim 6, wherein the base station is connected to the transmitters through a coaxial cable, a phone cable, a LAN cable or a wireless connection.

8. The method for wireless power transmission for electronic devices of claim 6, further includes the step of communicating information between the transmitter and receiver through communication circuitry and communication protocols in both the transmitter and receiver to identify the location of the electronic devices within the structure or rooms within the building.

9. The method for wireless power transmission for electronic devices of claim 6, wherein the digital signal processor or the microcontroller or the ASIC is a microprocessor controlling the time emission of pocket-forming, direction of pocket-forming, bounce angle of the pockets of energy, intensity of the pockets of energy when controlling the plurality of pocket-forming transmitters and further including the step of transmitting the pockets of energy to multiple receivers or a single receiver.

10. The method for wireless power transmission for electronic devices of claim 8, wherein the digital signal processor manages and controls the plurality of transmitter by controlling the communication circuitry.

11. The method for wireless power transmission for electronic devices of claim 8, wherein the power source is contained within the base station and is either AC or DC power supply.

12. The method for wireless power transmission for electronic devices of claim 11, wherein the conversion of the AC or DC power to SW waves is managed by the digital signal processor to produce SW waves in a wide variety of frequencies, wavelength, intensities and other SW characteristics.

13. The method for wireless power transmission for electronic devices of claim 6, wherein the step of generating SW waves is accomplished through oscillators and piezoelectric crystals to change the audio frequencies in different antenna elements.

14. The method for wireless power transmission for electronic devices of claim 8, wherein the communication circuitry uses standard wireless communication protocols such as Bluetooth, Wi-Fi, Zigbee or FM radio between the transmitter and receiver.

15. The method for wireless power transmission for electronic devices of claim 1, wherein the transducer elements in the transmitter and receiver operate in the frequency hands of 10 KHz to 50 KHz.

16. The method for wireless power transmission for electronic devices of claim 6, further includes the step of enhancing the range of wireless power transmission with a range enhancer, reflectors and repeaters located on the curtains, walls, floor, ceiling and furniture in predetermined positions around rooms of the structure.

17. The method for wireless power transmission for electronic devices of claim 6, wherein the electronic devices are restricted to a specific area and to a specific user to ensure safety and security in wireless power transmission within a structure of electronic devices.

18. The method for wireless power transmission to an electronic device within a predefined range of claim 1, further comprising the step of communicating between the receiver and the transmitter through the communication signals or pilot signals on conventional wireless communication protocols including Bluetooth, Wi-Fi, Zigbee or FM radio signals.

19. The method for wireless power transmission for electronic devices of claim 6, wherein the receivers of the electronic devices send communication signals to the closest transmitter further including the step of coding including delay encoding, orthogonal frequency-division multiplexing, code division multiplexing or other suitable binary coding for identifying electronic devices.

20. A method for wireless power transmission for an electronic device, comprising:
delivering a power request from the electronic device to a plurality of pocket-forming transmitters for emitting SW waves to form pockets of energy converging in 3-d space connected to a power source;
determining the requesting electronic device location;
identifying the electronic device to he charged;
prioritizing the electronic device to receive a charge;
checking the battery level of the electronic device to confirm the need for a charge;
meeting delivery criteria by the electronic device to be charged;
confirming the electronic device is within range of at least one transmitter for charging; and
delivering power to the electronic device to be charged or using a range enhancer to deliver the power to the electronic device.

21. The method for wireless power transmission for an electronic, device of claim 20, further including a receiver embedded with the electronic device wherein the transmitter and receiver further include communication circuitry for transferring information between the transmitter and receiver.

22. The method for wireless power transmission for electronic devices of claim 21, wherein the information communicated between the transmitter and receiver through the communication circuitry identifies the electronic device, a user, a battery level, a location of the electronic device or such other information for each electronic device within the predefined range of the transmitter.

23. The method for wireless power transmission for electronic devices of claim 20, wherein the transmitter include communication components to allow communication to various electronic devices including cell phones, smart phones, computers and other intelligent electronic devices.

24. The method for wireless power transmission for electronic devices of claim 20, further including a base station with a microprocessor and a power source to manage each transmitter in an independent manner or to operate all transmitters as a single transmitter.

25. An apparatus for wireless power transmission to an electronic device, comprising:
a plurality of pocket-forming transmitters having at least two or more transducer elements, at least one SW integrated circuit and a communication circuit;
a base station with at least one digital signal processor or micro-controller and a source of power for generating controlled SW waves to form pockets of energy consisting of constructive interference patterns of the generated SW waves to converge in 3-D space at predetermined locations; and
a receiver having a communication circuit embedded in the electronic device for requesting a charge from the transmitters within a building structure.

26. The apparatus for wireless power transmission to an electronic device of claim 25, wherein the transmitter and receiver include communication circuitry utilizing Bluetooth, infrared, Wi-Fi, FM radio or Zigbee signals for the various communication protocols between the receiver and the transmitter.

27. The apparatus for wireless power transmission to an electronic device of claim 25, Wherein the base station controlling the plurality of transmitters enables the use of all transmitters as a single transmitter for powering multiple electronic devices.
